(19) United States
(12) Patent Application Publication
(10) Pub. No.: US 2020/0166668 A1
(43) Pub. Date: May 28, 2020

(54) METHOD FOR TRACKING A MAGNET WITH AN ARRAY OF MAGNETOMETERS, COMPRISING A PHASE OF IDENTIFYING THE PRESENCE OF THE MAGNET AND OF A MAGNETIC DISTURBANCE

(71) Applicant: ISKN, Saint-Martin-d'Hères (FR)

(72) Inventors: Jean-Marie Dupre La Tour, Meylan (FR); Tristan Hautson, Fontaine (FR)

(21) Appl. No.: 16/618,076

(22) PCT Filed: May 29, 2018
(86) PCT No.: PCT/EP2018/063983

§ 371 Date: Nov. 27, 2019

(30) Foreign Application Priority Data
May 31, 2017 (FR) 1754807

(51) Int. Cl. G01V 3/08

(52) U.S. Cl. CPC G01V 3/08

(57) ABSTRACT

The present disclosure relates to a method for estimating the position of a magnet using a tracking device comprising an array of magnetometers (Mᵢ), comprising phases of determining an initial state vector associated with the magnet, of measuring a useful magnetic field emitted by a magnetic element, of estimating a magnetic field generated by the magnet, of calculating a bias between the estimated magnetic field and the measured magnetic field, and of updating the state vector on the basis of the bias. The method also comprises an identifying phase comprising a step of identifying the absence of the magnet with respect to the array of magnetometers and, where appropriate, a step of identifying the magnetic element as being a magnetic disturbance.

### CROSS-REFERENCE TO RELATED APPLICATIONS

This application is a national phase entry under 35 U.S.C. § 371 of International Patent Application PCT/EP2018/063983, filed May 29, 2018, designating the United States of America and published in French as International Patent Publication WO 2018/219891 A1 on Dec. 6, 2018, which claims the benefit under Article 8 of the Patent Cooperation Treaty to French Patent Application Serial No. 1754807, filed May 31, 2017.

### TECHNICAL FIELD

The present disclosure relates to a method for tracking a magnet with an array of magnetometers, in other words for estimating the successive positions of the magnet over time, comprising a phase for identifying the presence or absence of the magnet to be tracked, and where relevant, for identifying the presence of a magnetic perturbator in the neighborhood of the array of magnetometers.

### BACKGROUND

It is known practice to use at least one magnet in the framework of a system for measuring the trace of a magnetic pen on a writing medium. Here, the magnet is an object with which is associated a non-zero magnetic moment, for example, a permanent magnet fixed to a non-magnetic pen.

By way of example, the document WO2014/053526 describes a system for measuring the trace of a pen to which an annular magnet is fixed. The permanent magnet comprises a magnetic material, for example ferromagnetic or ferrimagnetic, uniformly distributed around a mechanical axis that coincides with the longitudinal axis of the pen.

The measurement of the trace of the pen is provided by a device for tracking the magnet, which device comprises an array of magnetometers, each magnetometer being designed to measure the magnetic field. A method for tracking the magnet estimates the position of the magnet at each measurement time by means of a recursive estimator of the Kalman filter type.

However, a magnetic perturbator, distinct from the magnet to be tracked, may be located in the neighborhood of the device for tracking the magnet. It is then able to cause a degradation of the tracking of the magnet.

### BRIEF SUMMARY

The aim of embodiments of the present disclosure is to overcome, at least in part, the drawbacks of the prior art and, more particularly, to provide a method for estimating a position of the magnet, the latter being intended to be moved with respect to an array of magnetometers, comprising an identification phase allowing it to be determined whether the magnet to be tracked is absent, and where relevant, allowing the potential presence of a magnetic perturbator to be identified in the neighborhood of the array of magnetometers. The subject of the present disclosure is a method for estimating a position of the magnet by a tracking device comprising an array of magnetometers designed to measure a magnetic field, the method being implemented by a processor, comprising the following phases:
determination of a state vector, referred to as initial state vector, associated with the magnet, for an initial measurement time, the state vector comprising variables representative of the position of the magnet with respect to the array of magnetometers;
measurement by the array of magnetometers of a magnetic field referred to as useful magnetic field, produced by a magnetic element, at a measurement time;
estimation of a magnetic field generated by the magnet, as a function of the state vector obtained at a preceding measurement time, on the basis of a predetermined model expressing a relationship between the magnetic field generated by the magnet and the state vector of the magnet;
calculation of a bias by a difference between the estimated magnetic field generated by the magnet and the measured useful magnetic field produced by the magnetic element;
update of the state vector as a function of the calculated bias, thus allowing an estimated position of the magnet at the measurement time to be obtained; and
iteration of the phases for measurement, for estimation, for calculating the bias and for updating, on the basis of the updated state vector, while incrementing the measurement time.

According to the present disclosure, the method comprises an identification phase, at at least one measurement time, comprising the following steps:
calculation of a difference between at least one variable of the updated state vector and a predetermined reference value representative of the presence of the magnet with respect to the array of magnetometers, and identification of the absence of the magnet when the difference is greater than a predetermined threshold difference value, in which case the following steps are carried out:
   calculation of a parameter referred to as indicator from the useful magnetic field measured at the measurement time; and
   comparison of the indicator with a predetermined threshold identification value, and identification of the magnetic element as being a magnetic perturbator when at least one of the values of the indicator is greater than or equal to the threshold identification value.

The magnetic element may be the magnet to be tracked, a magnetic perturbator, or even an object that is neither the magnet to be tracked nor a magnetic perturbator. Furthermore, the identification phase may be carried out at each measurement time, or for some of the measurement times. Finally, the preceding measurement time may be the measurement time at the preceding increment, or, for the first increment, the initial measurement time.

Certain preferred but non-limiting aspects of this method are the following.

The indicator may be equal, at the measurement time, to the ratio of the useful magnetic field over at least one predetermined constant representative of a bias of at least one of the magnetometers.

The step for calculating the difference may comprise a comparison of an estimated position of the magnetic element coming from the state vector with a predetermined reference position representative of the presence of the magnet with respect to the array of magnetometers.

The state vector may furthermore comprise variables representative of a magnetic moment of the magnetic element, in which case the step for calculating the difference may comprise a comparison of an estimated magnetic moment of the magnetic element coming from the state vector with a reference magnetic moment representative of the magnet.

The step for calculating a difference may comprise an identification of the presence of the magnet with respect to the array of magnetometers when the differences relating to the position and to the magnetic moment of the magnetic element are less than or equal to predetermined threshold difference values, in which case the following steps are carried out:
calculation of a term, referred to as second indicator, using a difference parameter defined as being a function of a difference between an estimated magnetic field generated by the magnet for the state vector obtained at the preceding measurement time or updated, on the basis of the predetermined model, and the useful magnetic field measured at the measurement time; and
comparison of the second indicator with a predetermined second threshold identification value, and identification of a magnetic perturbator when at least one of the values of the indicator is greater than or equal to the second threshold identification value.

The phases for estimation, for calculating the bias and for updating may be carried out by a Bayesian recursive estimation algorithm.

The estimation phase may comprise:
a step for obtaining a state vector, referred to as predicted state vector, at the measurement time as a function of a state vector obtained at a preceding measurement time, and
a step for calculating the estimated magnetic field for the predicted state vector, and the phase for calculating the bias may comprise:
a step for calculating the bias, referred to as innovation, as the difference between the estimated magnetic field for the predicted state vector and the measured useful magnetic field.

The difference parameter may be equal to the innovation.

The difference parameter may be equal to the difference between an estimated magnetic field generated by the magnet for the updated state vector, and the useful magnetic field measured at the measurement time.

The phases for estimation, for calculating the bias and for updating may be carried out by an algorithm for optimization by iterative minimization of the bias, referred to as cost function, at the measurement time.

The phase for identification of the magnetic perturbator may comprise a step for sending a signal to the user inviting them to move the magnetic perturbator away from the array of magnetometers, for as long as at least one of the values of the indicator is greater than or equal to a predetermined threshold identification value.

The present disclosure also relates to an information recording medium, comprising instructions for the implementation of the method according to any one of the preceding features, these instructions being intended to be executed by a processor.

### BRIEF DESCRIPTION OF THE DRAWINGS

Other aspects, aims, advantages and features of embodiments of the present disclosure will become more clearly apparent upon reading the following detailed description of preferred embodiments thereof, given by way of non-limiting example, and presented with reference to the appended drawings in which:

FIG. 1 is a schematic perspective view of a device for tracking a magnet comprising an array of magnetometers according to one embodiment, in the neighborhood of which a magnetic perturbator is situated;

FIG. 2 is a flow diagram of one example of a method for estimating a position of the magnet, in which the estimator is a Bayesian filter;

FIG. 3 is a flow diagram of a method for estimating a position of the magnet according to a first embodiment, in which the estimator is a Bayesian filter, comprising a phase for identifying a magnetic perturbator in the case where the magnet to be tracked has previously been identified as being absent;

FIG. 4 is a flow diagram of the identification phase according to one variant of the embodiment illustrated in FIG. 3, furthermore allowing the magnetic perturbator to be identified in the case where the magnet to be tracked has been identified as being present;

FIGS. 5A and 5B are schematic cross-sectional (FIG. 5A) and top (FIG. 5B) views of an array of magnetometers in the neighborhood of which a magnetic perturbator is situated; and

FIGS. 6 and 7 illustrate, respectively, a flow diagram of a method for estimating a position of the magnet according to a second embodiment, in which the estimator is an algorithm for optimizing by minimization of a cost function, and the corresponding identification phase.

### DETAILED DESCRIPTION

In the figures and in the following part of the description, the same references represent identical or similar elements. In addition, the various elements are not shown to scale for the sake of clarity of the figures. Furthermore, the various embodiments and variants are not mutually exclusive and may be combined together. Unless otherwise stated, the terms “substantially,” “approximately,” and “of the order of” mean to within 10%.

The present disclosure relates to a method for estimating the position of a magnet with respect to an array of magnetometers of a magnet tracking device, comprising an identification phase allowing it to be determined whether a magnetic element situated in the neighborhood of the array of magnetometers is not the magnet to be tracked, and when such is the case, allowing it to be determined whether this magnetic element is a magnetic perturbator likely to interfere with the further tracking of the magnet. In one advantageous variant, the method may determine whether the magnet to be tracked is present within a tracking region of the array of magnetometers, and when such is the case, determine the potential presence of a magnetic perturbator.

The magnet intended to be tracked comprises a material exhibiting a magnetization, for example a remnant magnetization, for which a magnetic moment is defined. The magnet may be a cylindrical, for example annular, permanent magnet such as illustrated in the aforementioned document WO2014/053526. It may also take the form of a utensil or of a pen equipped with such a magnet or comprising a different permanent magnet, for example, integrated into the body of the pen. The term ‘pen’ is to be understood in the wider sense and may encompass pens, felt tips, paint brushes or any other writing or drawing implement.

The magnetic material is preferably ferrimagnetic or ferromagnetic. It has a spontaneous non-zero magnetic moment even in the absence of an external magnetic field. It may exhibit a coercive magnetic field higher than 100 A.m⁻¹ or 500 A.m⁻¹ and the strength of the magnetic moment is preferably higher than 0.01 A.m² or even 0.1 A.m², for example, equal to around 0.17 A.m². In the following, it is considered that the permanent magnet may be approximated by a magnetic dipole, but other models may be used. The magnetic axis of the object is defined as being the axis collinear with the magnetic moment of the object.

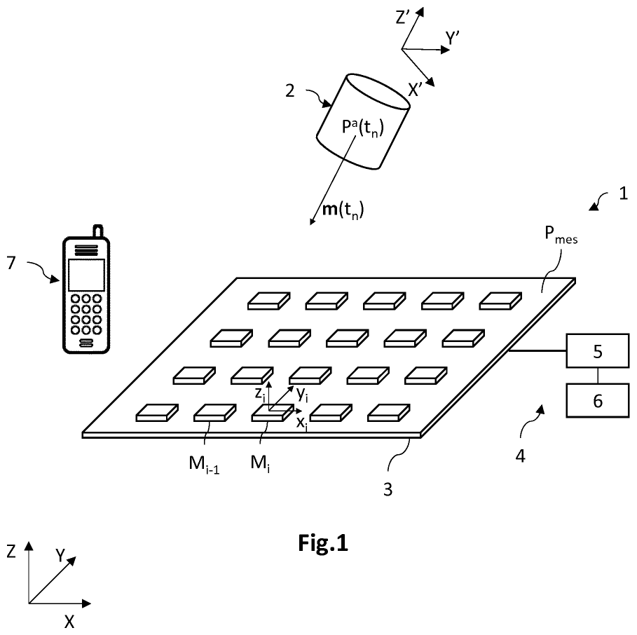

FIG. 1 is a schematic and partial perspective view of a device 1 for tracking a magnet 2 according to one embodiment. Here, the magnet 2 to be tracked is a cylindrical, for example annular, permanent magnet that is designed to be fixed to a pen (not shown).

The device 1 (also referred to herein as a “tracking device”) is designed to measure the magnetic field produced by the magnet 2, at various measurement times, during the course of a tracking period T, in a reference frame XYZ, and to estimate the position and the magnetic moment of the magnet 2 on the basis of the measured values of the magnetic field. In other words, the tracking device 1 allows the position and the orientation of the permanent magnet 2 to be determined at various moments in time in the reference frame XYZ. As described hereinbelow, the tracking device 1 furthermore provides the identification allowing it to be determined whether the magnet 2 to be tracked is absent from a tracking region, and when such is the case, whether the magnetic element situated in the neighborhood of the array of magnetometers is a magnetic perturbator 7, distinct from the magnet 2 to be tracked.

Here and for the following part of the description a right three-dimensional reference frame (X,Y,Z) is defined, where the axes X and Y form a plane parallel to the measurement plane of the array of magnetometers, and where the axis Z is oriented in a direction substantially orthogonal to the measurement plane. In the following part of the description, the terms “vertical” and “vertically” are understood as being related to an orientation substantially parallel to the axis Z, and the terms “horizontal” and “horizontally” as being related to an orientation substantially parallel to the plane (X,Y). Furthermore, the terms “lower” and “upper” are understood as being related to an increasing positioning when moving away from the measurement plane in the direction +Z.

The position Pₐ of the magnet 2 corresponds to the coordinates of the geometrical center of the magnet 2, in other words to the unweighted barycenter of the whole set of points of the magnet 2. Thus, the magnetic moment m of the magnet has the components (mₓ, m_{y}, m_{z}) in the reference frame XYZ. Its norm, also called intensity or amplitude, is denoted ∥m∥ or m. It is designed to be situated in a tracking region, the latter being, on the one hand, distinct from the measurement plane Pₘₑₛ and, on the other, laterally bounded, by way of illustration, by the position of the magnetometers situated at the periphery of the array, the perimeter of the protection plate 3, or a circle going through the magnetometers furthest from the center of the array. Other definitions of the lateral boundary of the tracking region are possible.

The tracking device 1 comprises an array of magnetometers Mᵢ arranged with respect to one another in such a manner as to form a measurement plane Pₘₑₛ. The number of magnetometers Mᵢ may be, for example, greater than or equal to two, preferably greater than or equal to sixteen, for example equal to thirty-two, notably when they are tri-axial magnetometers. The array of magnetometers comprises however at least three measurement axes separate from one another and non-parallel to one another.

The magnetometers Mᵢ are fixed to a protection plate 3 and may be situated on the rear face of the plate, the latter being made from a non-magnetic material. “Fixed” is understood to mean that they are assembled onto the plate without any degree of freedom. Here, they are aligned in rows and columns, but may be mutually positioned in a substantially random manner. The distances between each magnetometer and its neighbors are known and constant over time. For example, they may be in the range between 1 cm and 4 cm.

The magnetometers Mᵢ each have at least one measurement axis, for example three axes, denoted xᵢ, yᵢ, zᵢ. Each magnetometer therefore measures the amplitude and the direction of the magnetic field B perturbed by a magnetic element, whether this is the magnet 2 to be tracked or a magnetic perturbator 7. More precisely, each magnetometer Mᵢ measures the norm of the orthogonal projection of the magnetic field B along the axes xᵢ, yᵢ, zᵢ of the magnetometer. One calibration parameter for the magnetometers NI may be the noise associated with the magnetometers, here of the order of 0.4 μT. Perturbed magnetic field B is understood to mean the ambient magnetic field B^{amb}, in other words not perturbed by any magnetic element, to which the magnetic field B^{a} generated by the magnet is to be added. Other magnetic components may be added, such as a component associated with the noise of the sensors, together with a component linked to the presence of a magnetic perturbator.

The tracking device 1 furthermore comprises a processing unit 4 designed to calculate the position of the magnet 2 and its magnetic moment in the reference frame XYZ based on the measurements of the magnetometers Mᵢ. In addition, as described hereinbelow, the processing unit 4 is able to determine whether the magnet 2 is absent from the tracking region, and advantageously whether it is present within the tracking region, and where relevant, to identify the magnetic element situated in the neighborhood of the array of magnetometers as being a magnetic perturbator 7.

For this purpose, each magnetometer Mᵢ is electrically connected to the processing unit via a data transmission bus (not shown). The processing unit 4 comprises a programmable processor 5 designed to execute instructions recorded on an information recording medium. It furthermore comprises a memory 6 containing the instructions needed for the implementation of the method for tracking the magnet 2 and of a phase for identifying the magnetic perturbator 7 by the processor. The memory 6 is also designed to store the information calculated at each measurement time.

The processing unit 4 implements a mathematical model associating the position of the magnet 2 to be tracked in the reference frame XYZ, and also the orientation and the intensity of its magnetic moment, with the measurements of the magnetometers Mᵢ. This mathematical model is constructed from the equations of electromagnetism, in particular of magnetostatics, and has as input parameters, notably the positions and orientations of the magnetometers in the reference frame XYZ. Here, this model is non-linear. The processing unit implements an algorithm for estimating its solution such as, for example, a Bayesian filtering or an optimization or any other algorithm of the same type.

Preferably, in order to be able to approximate the magnet 2 to be tracked to a magnetic dipole, the distance between the magnet 2 to be tracked and each magnetometer Mᵢ is greater than two times, or even three times the largest dimension of the magnet 2. This dimension may be less than 20 cm, or less than 10 cm, or even less than 5 cm. The magnet 2 to be tracked may be modeled by a dipolar model, amongst others, depending notably on the distance between the magnet 2 to be tracked and the array of magnetometers.

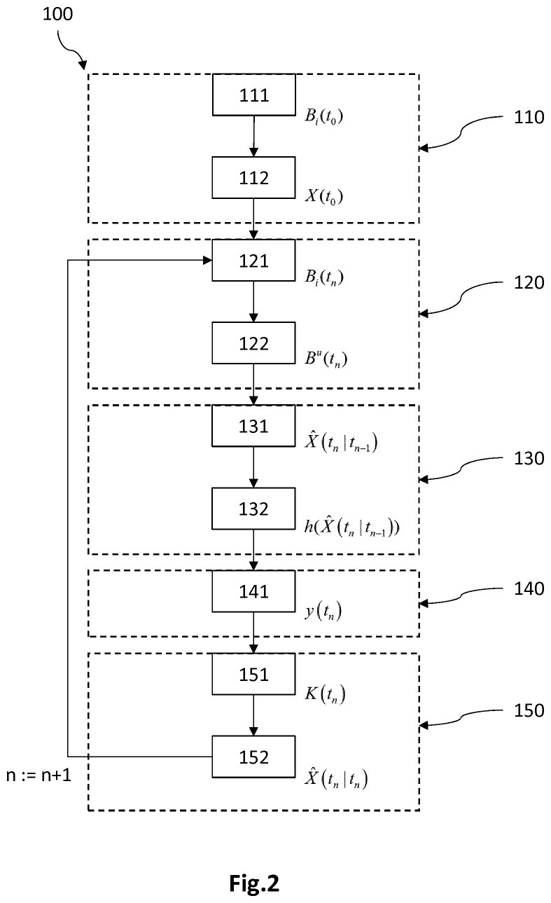

FIG. 2 is a flow diagram of one example of a method 100 for estimating a position of the magnet carried out by the tracking device, during which the magnet is moved relative to the array of magnetometers in the reference frame XYZ, and more precisely within the tracking region, in the absence of any magnetic perturbator situated in the neighborhood of the array of magnetometers. Here, the tracking method is described according to a first embodiment, in which the estimation algorithm implemented is a Bayesian filtering. In this example, the Bayesian filtering is a Kalman filter, such as an extended Kalman filter.

The method for estimating the position, also referred to as tracking method, comprises an initialization/reset phase 110. This phase comprises the measurement (step 111) of the magnetic field generated by the magnet and the initialization/reset (step 112) of a state vector X associated with the magnet, for a reference time t₀.

For this purpose, during a first step 111, at a reference time t₀, the magnetic field Bᵢ(t₀) is measured by each magnetometer n of the array. During this step, the permanent magnet might not be present, hence not detectable by the array of magnetometers, such that the magnetic field Bᵢ(t₀) measured by the magnetometer n comprises the following components:

$$\begin{matrix}{B}_{i} ( {t}_{0} ) = {B}_{i}^{amb} + {B}_{i}^{n} ( {t}_{0} ) + {B}_{i}^{a} ( {t}_{0} ) \\ = {B}_{i}^{amb} + {B}_{i}^{b} ( {t}_{0} )\end{matrix}$$

where Bᵢ^{amb} is a component associated with the Earth's magnetic field, where Bᵢⁿ is a component associated with the noise from the environment and from the sensors, which, in the absence of a magnetic perturbator in the neighborhood of the tracking device, corresponds essentially to a component Bᵢ^{b} associated with the noise of the corresponding magnetometer n, and where Bᵢ^{a} is a component (here zero) of the magnetic field generated by the magnet and measured by the magnetometer Mᵢ.

The magnetic perturbator is an unwanted object different from the magnet to be tracked, this object being capable of producing a spurious magnetic field B^{p} and/or of leading to the formation of an induced magnetic field H^{p,i}.B^{a} by interaction with the magnetic field B^{a} of the magnet 2 to be tracked.

During a step 112, a state vector X(t₀) is assigned to the permanent magnet, at the reference time t₀. The state vector is formed of variables representative of the position (x,y,z) and advantageously of the magnetic moment (mₓ,m_{y},m_{z}) of the magnet 2 in the reference frame XYZ. The position of the magnet and the coordinates of the magnetic moment may be defined arbitrarily or may correspond to predetermined values. The position may thus be the center of the tracking region, and the magnetic moment may correspond to an orientation of the magnet toward the array of magnetometers, with an intensity corresponding to the reference intensity, for example, 0.17 A.m².

The following steps are carried out iteratively at an incremented measurement time tₙ, the time being discretized at a given sampling frequency, for example, at 140 Hz. With each iteration of rank n is associated a measurement time tₙ, also referred to as the current time.

The tracking method subsequently comprises a measurement phase 120. This phase comprises the measurement of the magnetic field by the array of magnetometers at the measurement time tₙ and the calculation of the magnetic field, referred to as useful magnetic field, Bu generated by the magnet 2. It is considered here that the magnet 2 to be tracked is present and that there is no magnetic perturbator 7 situated in the neighborhood of the array of magnetometers.

During a step 121, at the measurement time tₙ, the magnetic field Bᵢ(tₙ) is measured by each magnetometer n of the array. During this step, the permanent magnet is detectable by the array, such that the magnetic field Bᵢ(t) measured by each magnetometer NI comprises the following components:

$$\begin{matrix}{B}_{i} ( {t}_{n} ) = {B}_{i}^{amb} + {B}_{i}^{n} ( {t}_{n} ) + {B}_{i}^{a} ( {t}_{n} ) \\ = {B}_{i}^{amb} + {B}_{i}^{b} ( {t}_{n} ) + {B}_{i}^{a} ( {t}_{n} )\end{matrix}$$

where B^{a} is the magnetic field generated by the permanent magnet at the current time tₙ, B^{b} the noise associated with the sensors and B^{amb} the ambient field.

During a step 122, the magnetic field B″ referred to as useful is calculated from the measurements of the magnetic field Bᵢ(t₀) and Bᵢ(tₙ). Here, it corresponds to a vector whose dimensions depend on the number of magnetometers and on the number of measurement values obtained by each magnetometer. More precisely, the useful magnetic field B^{u} is obtained by subtraction of the magnetic field B(t₀) measured at the reference time t₀ from the magnetic field B(tₙ) measured at the measurement time tₙ:

$$\begin{matrix}{B}_{i}^{u} ( {t}_{n} ) = {B}_{i} ( {t}_{n} ) - {B}_{i} ( {t}_{0} ) \\ = {B}_{i}^{a} ( {t}_{n} ) - {B}_{i}^{a} ( {t}_{0} ) = {B}_{i}^{a} ( {t}_{n} )\end{matrix}$$

where the differential in the Earth's component B^{amb} of the magnetic field at times t₀ and tₙ may be neglected, as can that of the component B^{b} associated with the noise from the magnetometers. There thus essentially remains, aside from potential terms associated with an error in calibration and/or with an offset coming from a possible magnetization of the magnetometers, the component B^{a} of the magnetic field generated by the magnet at the current time tₙ.

The tracking method subsequently comprises a phase 130 for estimating a magnetic field generated by the magnet as a function of a state vector obtained at a preceding measurement time.

During a step 131, a state vector, referred to as predicted state vector, \hat{X}(tₙ|tₙ₋₁) associated with the magnet is predicted based on the estimated state \hat{X}(tₙ₋₁|tₙ₋₁) at the preceding time tₙ₋₁ or based on the state \hat{X}(t₀) estimated at the initial time of the phase 110. The predicted state of the magnet may be calculated from the following relationship:

\hat{X}(tₙ|tₙ₋₁)=F(tₙ).\hat{X}(tₙ₋₁|tₙ₋₁)=\hat{X}(tₙ₋₁|tₙ₋₁)

where F(tₙ) is a prediction matrix that links the preceding estimated state to the current predicted state \hat{X}(tₙ|tₙ₋₁). In this example, the prediction matrix F is the identity matrix, but other formulations are possible. Thus, as a variant, the prediction function may take into account one or more preceding states, and potentially an estimation of kinematic parameters relating to a motion and/or to a rotation of the magnet during preceding measurement times.

During this same step 131, the matrix P(tₙ|tₙ₋₁) for a priori estimation of the covariance of the error is also calculated, which corresponds to the measurement of the precision of the current predicted state \hat{X}(tₙ|tₙ₋₁), using the following relationship:

P(tₙ|tₙ₋₁)=F(tₙ.P(tₙ₋₁|tₙ₋₁).F^{T}(tₙ)+Q(tₙ)=P(tₙ₋₁|tₙ₋₁)+Q(tₙ)

where F(tₙ) here is the identity matrix, Q(tₙ) is the covariance matrix of the noise of the process, T is the transposition operator, and P(tₙ₋₁|tₙ₋₁) is the covariance matrix of the error coming from the preceding time tₙ₋₁. During the first iteration at n=1, the matrix P(tₙ₋₁|tₙ₋₁) may be initialized by a diagonal matrix.

During a step 132, the magnetic field referred to as estimated magnetic field, generated by the magnet, is calculated as a function of the predicted state vector \hat{X}(tₙ|tₙ₋₁), at the current time tₙ, using a function h referred to as observation function, also called measurement function. The observation function h is based on a physical model constructed from the equations of electromagnetism, which associates an estimated magnetic field with the estimated values of the position (x,y,z) and of the magnetic moment (mₓ,m_{y},m_{z}) of the magnet. Thus, the term may be expressed according to the following relationship:

h(\hat{X}(tₙ|tₙ₋₁))=\hat{B}^{a}(tₙ)+ε^{m}

where \hat{B}^{a} is the component representative of the estimated magnetic field of the magnet at the current time tₙ, and ε^{m} is a component associated with errors of the physical model h.

The tracking method subsequently comprises a phase 140 for calculating a bias. During a step 141, the bias at the current time tₙ, here the innovation y(tₙ), is calculated by a difference between the estimated magnetic field h(\hat{X}(tₙ|tₙ₋₁)) at the current time tₙ, and the useful magnetic field measured Bᵢ^{u}(tₙ) at the current time tₙ:

$$\begin{matrix}y ( {t}_{n} ) = {B}^{u} ( {t}_{n} ) - h ( \hat{X} ( {t}_{n} \vert {t}_{n - 1} ) ) \\ = {B}^{a} ( {t}_{n} ) - ( {\hat{B}}^{a} ( {t}_{n} ) + {ɛ}^{m} ) \\ = - {ɛ}^{m}\end{matrix}$$

which is then essentially equal, ignoring the sign, to the errors ε^{m} of the physical model, given that the measured magnetic field from the magnet B^{a} substantially corresponds to its estimation obtained during the step 132.

The tracking method subsequently comprises a phase 150 for calculating the estimated position of the magnet at the current time tₙ. This phase consists in updating the state vector current \hat{X}(tₙ≡tₙ of the magnet by correcting the state vector previously obtained, namely here the predicted state current \hat{X}(tₙ|tₙ₋₁), as a function of the calculated bias y(tₙ).

During a step 151, a term referred to as the Kalman gain K(tₙ) is calculated at the current time tₙ based on the following relationship:

K(tₙ)=P(tₙ|tₙ₋₁).H^{T}(tₙ).S(tₙ)⁻¹

where the estimation matrix P(tₙ|tₙ₋₁) is obtained during the step 131, H is the observation matrix, defined here as being the Jacobian H=∂h/∂Xᵤ of the observation function h, with u the index of the variables of the state vector, and S is the covariance of the innovation, defined as being equal to H(tₙ).P(tₙ|tₙ₋₁).H^{T}(tₙ)+R(tₙ) where R is the covariance matrix of the measurement and is hence representative of the noise from the sensors.

During a step 152, the estimation of the state vector \hat{X} at the measurement time tₙ is carried out by updating the predicted state current \hat{X}(tₙ|tₙ₋₁) based on the product of the innovation term y(tₙ) and of the Kalman gain K(tₙ), such as expressed by the following relationship:

\hat{X}(tₙ|tₙ)=\hat{X}(tₙ|tₙ₋₁)+y(tₙ).K(tₙ)

The covariance matrix of the error is also updated by the following relationship:

P(tₙ|tₙ)=(I−K(tₙ).H(tₙ)).P(tₙ|tₙ₋₁)

where I is the identity matrix.

The estimated position at the measurement time tₙ is thus obtained based on the variables of the estimated state vector \hat{X} relating to the position (x,y,z) of the magnet in the reference frame XYZ. The time is subsequently incremented by an additional increment, and the method repeats the preceding steps described at the next current time tₙ₊₁, here based on the measurement phase 120. The tracking of the magnet in the reference frame XYZ is thus carried out.

In the framework of a Bayesian filter such as the Kalman filter, which comprises a prediction phase and an update phase, the prediction is carried out during the step 131, and the update by the steps 132, 141, 151 and 152.

However, the inventors have highlighted that it is important to identify, prior to the tracking of the magnet, the effective presence of the magnet in the tracking region of the array of magnetometers, and, in the case where the magnet to be tracked is identified as not being present, to identify the potential presence of a magnetic perturbator in the neighborhood of the array of magnetometers. Indeed, the presence of a magnetic perturbator may lead to an increase in the uncertainty associated with the estimated position of the magnet in the reference frame XYZ or even interfere with the convergence of the algorithm for estimating the position of the magnet.

In the case where the magnet is present in the tracking region and where a magnetic perturbator is situated in the neighborhood of the array of magnetometers (whether it be within or outside of the tracking region), the magnetic field Bᵢ(tₙ) measured at the measurement time tₙ becomes, for each sensor of rank i:

$$\begin{matrix}{B}_{i} ( {t}_{n} ) = {B}_{i}^{amb} + {B}_{i}^{a} ( {t}_{n} ) + {B}_{i}^{n} ( {t}_{n} ) \\ = {B}_{i}^{amb} + {B}_{i}^{a} ( {t}_{n} ) + ( {B}_{i}^{p} ( {t}_{n} ) + {H}_{i}^{p , i} ( {t}_{n} ) \cdot {B}_{i}^{a} ( {t}_{n} ) + {B}_{i}^{b} ( {t}_{n} ) )\end{matrix}$$

where the component Bⁿ now comprises an additional term B^{p} corresponding to the permanent magnetic field generated by the magnetic perturbator, and potentially a term H^{p,i}.B^{a} corresponding to the induced magnetic field coming from a magnetic interaction between the perturbator and the magnet.

The useful magnetic field B^{u}(tₙ) calculated at the current time tₙ becomes, for each sensor of rank i:

$$\begin{matrix}{B}_{i}^{u} ( {t}_{n} ) = {B}_{i} ( {t}_{n} ) - {B}_{i} ( {t}_{0} ) \\ = {B}_{i}^{n} ( {t}_{n} ) + {B}_{i}^{a} ( {t}_{n} ) \\ = ( {B}_{i}^{p} ( {t}_{n} ) + {H}_{i}^{p , i} ( {t}_{n} ) \cdot {B}_{i}^{a} ( {t}_{n} ) ) + {B}_{i}^{a} ( {t}_{n} )\end{matrix}$$

which thus comprises, aside from the term B^{a} for the magnetic held generated by the magnet, a term associated with the magnetic perturbator (the terms associated with the calibration errors and/or with the magnetization offset are not detailed here).

Also, the innovation term y(tₙ) now becomes:

$$\begin{matrix}y ( {t}_{n} ) = {B}^{u} ( {t}_{n} ) - h ( \hat{X} ( {t}_{n} \vert {t}_{n - 1} ) ) \\ = ( {B}_{i}^{p} ( {t}_{n} ) + {H}_{i}^{p , i} ( {t}_{n} ) \cdot {B}_{i}^{a} ( {t}_{n} ) ) - {ɛ}^{m}\end{matrix}$$

where the noise term associated with the presence of the magnetic perturbator is added to the term linked to the errors of the physical model ε^{m}.

It will then be understood that the recursive estimator, which tends to minimize the innovation term y, notably by means of the Jacobian H(tₙ), and hence to minimize the errors of the physical model ε^{m} in the absence of a magnetic perturbator, may be perturbed by the presence of the term linked to the magnetic perturbator. An increase in the relative error associated with the estimated position of the magnet is then possible, or even a difficulty for the algorithm to converge.

By way of example, the presence of a mobile telephone in the neighborhood of the array of magnetometers can cause such perturbations. The mobile telephone, when it is sufficiently close to the array of magnetometers, is then treated as a magnetic perturbator. More generally, this can, for example, be any ferromagnetic material other than the magnet to be tracked, such as parts of a table, of an audio headset, of an electronic apparatus, etc.

Thus, it is important, prior to carrying out the tracking of the magnet to be tracked, to determine whether this magnet to be tracked is absent, and when such is the case, to determine whether there is a magnetic perturbator able to degrade the quality of the later tracking of the magnet. As detailed hereinbelow, it may furthermore be advantageous to determine whether the magnetic element corresponds or not to the magnet to be tracked.

When the magnetic element is situated outside of the tracking region, whether this be a magnet intended to be tracked later on or a potential magnetic perturbator such as a loudspeaker or metallic portions of a table, the magnet to be tracked is considered as being absent. Similarly, when the magnetic element, whether it be situated or otherwise within the tracking region, has a magnetic intensity that does not correspond substantially to a reference intensity, the magnet to be tracked is considered as being absent. When the magnetic element is situated within the tracking region and its magnetic intensity corresponds substantially to a reference intensity, it then corresponds to the magnet to be tracked, and in this case, it is advantageous to determine whether a magnetic perturbator is present or not.

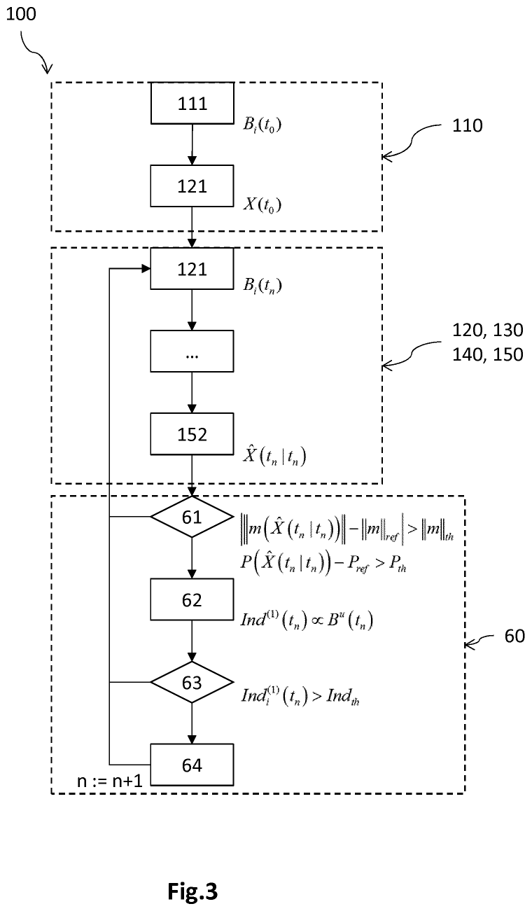

FIG. 3 is a flow diagram of a method for estimating a position of the magnet according to a first embodiment, where the position of the magnet here is estimated by means of a Bayesian recursive estimator, or Bayesian filter, such as a Kalman filter, for example an extended Kalman filter. The method comprises an identification phase 60 allowing it to be identified, via a first test, whether the magnet to be tracked is absent, and when such is the case, to determine if this magnetic element is a magnetic perturbator.

The identification phase 60 first of all allows the potential absence of the magnet to be tracked, then of a magnetic perturbator, to be determined with the aim, for example, of indicating to the user to move the perturbator away from the array of magnetometers, or of identifying magnetometers situated near to the perturbator measurements of which would not be taken into account in the estimation of the position of the magnet. The tracking of the magnet will thus be able to be carried out with the required precision and/or while minimizing the risks of failure of convergence of the estimation algorithm.

Thus, the method 100 for tracking the magnet comprises the initialization/reset phase 110, the measurement phase 120, the estimation phase 130, the phase 140 for calculating the bias, and the update phase 150. These steps are identical or similar to those previously detailed and are not therefore described again. The method 100 comprises the additional identification phase 60, implemented after the update phase 150.

During a step 61, it is determined whether the magnet to be tracked is absent, for example, whether the magnetic element associated with the state vector X is present or not within the tracking region. For this purpose, a difference is calculated between at least one variable of the updated state vector t) and a predetermined threshold difference value, the latter being representative of the magnet to be tracked situated within the tracking region.

The position state variable of the magnetic element P(X(t, t)) may then be compared with a reference position P_{ref}, for example, the position of the center of the tracking region or the position of the perimeter of the tracking region. Thus, a first test of absence of the magnet to be tracked may be written:

P(\hat{X}(tₙ|tₙ))−P_{ref}>Pₜₕ

where the constant Pₜₕ may be substantially zero in the case of the perimeter of the tracking region, or be substantially equal to a percentage of the reference position P_{ref}.

In the case where this test is verified, in other words when at least one of the variables of the position of the magnetic element P(\hat{X}(tₙ|tₙ)) is effectively outside of the tracking region, the magnet to be tracked is identified as being absent. The steps 62 and 63 are then carried out allowing it to be identified whether the magnetic element, then situated outside of the tracking region but in the neighborhood of the array of magnetometers, is a magnetic perturbator likely to degrade the later tracking of a magnet 2.

As a variant or as a complement to the position test, the state variable relating to the magnetic moment of the magnetic element m(\hat{X}(tₙ|tₙ)), and preferably the intensity of the moment ∥m(\hat{X}(tₙ|tₙ))∥, may be compared with a reference intensity ∥m∥_{ref}. Thus, another test of absence of the magnet to be tracked may be written:

|∥m(\hat{X}(tₙ|tₙ))∥−∥m∥_{ref}|>∥m∥ₜₕ

where the constant ∥m∥ₜₕ may be, for example, of the order of 20% of the reference value ∥m∥_{ref}. Thus, when this test is verified, in other words when the moment of the magnetic element has an intensity that does not substantially correspond to a reference intensity, the magnet to be tracked is identified as being absent. The steps 62 and 63 are then carried out.

During the step 61, the test on the position and/or the test on the moment may be carried out. In the case where the two tests are carried out, it is sufficient for at least one of the two to be verified in order for the magnet to be tracked to be identified as being absent, and for then proceeding to steps 62 and 63.

During a step 62, a first indicator Ind⁽¹⁾ is calculated at the current time tₙ from the useful magnetic field B^{u}(tₙ) measured at the measurement time. The indicator Ind⁽¹⁾(tₙ) may thus be equal to the norm 2 of the useful field B^{u}(tₙ), or, preferably, be equal to the ratio of the norm 2 of the useful magnetic field B^{u}(tₙ) over a predetermined constant c representative of a bias of at least one of the magnetometers. Thus, the indicator Ind⁽¹⁾(tₙ) is preferably calculated from the following relationship, here by a sensor of rank i:

$${Ind}_{i}^{( 1 )} ( {t}_{n} ) = \frac{‖ {B}_{i}^{u} ( {t}_{n} ) ‖}{c}$$

where the constant c may be a value representative of the sensor noise, for example equal to around 0.3 μT, or a value representative of a threshold of detection of a magnetic perturbator, for example equal to around 10 μT. This constant c may also be representative of a calibration error or of a measurement error linked to a magnetization of at least one magnetometer. As a variant, the values of the indicator term Ind(tₙ) may be calculated for each measurement axis of the sensors, while adapting as appropriate the norm used.

During a step 63, the indicator Ind⁽¹⁾(tₙ) is compared with a predetermined threshold identification value Indₜₕ, and when it is higher than this, the magnetic element is then identified as being a magnetic perturbator. In the case where the indicator Ind⁽¹⁾(tₙ) is a matrix quantity, each value Indᵢ⁽¹⁾(tₙ) of the indicator is compared with the threshold value Indₜₕ, where i is an index of the rank of the values of the indicator Ind⁽¹⁾(tₙ), and the magnetic element is identified as being a magnetic perturbator when at least one value Ind⁽¹⁾(tₙ) is higher than the threshold value Indₜₕ. The threshold value may thus be equal to around 10 μT. Similarly, when the indicator Ind⁽¹⁾(tₙ) is a scalar, the latter is compared with the threshold value Indₜₕ.

During a step 64, a signal may be sent to the user inviting them to move the perturbator until each value Indᵢ⁽¹⁾, at a later measurement time tₙ, becomes lower than the threshold value. The signal may be a piece of information displayed on a display screen representing the array of magnetometers. The information displayed may be presented as a so-called heat map for which an intensity scalar is assigned to each magnetometer Mᵢ, the intensity scalar corresponding to a value Indᵢ⁽¹⁾ of the indicator.

Advantageously, the values of the indicator Ind⁽¹⁾(tₙ) are weighted by a weighting factor, or even simply capped in such a manner that the values of the indicator are scaled between a minimum value, for example 0, and a maximum value, for example 255, in such a manner as to accentuate the weak magnetic perturbations. In the case where the indicator Ind₍₁₎ does not return to a value less than the threshold value after a predetermined time delay, the initialization/reset phase 110 may be carried out. It may furthermore comprise the low-pass filtering step with the aim of reducing the influence of the kinematics potentially present between two successive state vectors.

Thus, the method 100 for tracking the magnet comprises an identification phase 60 allowing it to be simply determined whether the magnet to be tracked is absent, in other words, here, whether the magnetic element associated with the state vector is positioned outside of the tracking region, and when such is the case, to be determined whether this magnetic element is a magnetic perturbator likely to degrade the quality of the later tracking of the magnet. The first indicator Ind⁽¹⁾(tₙ) then uses the information relative to the magnetic perturbator contained in the measured useful magnetic field B^{u}(tₙ). Having to use a device and method specific and dedicated to the identification of the magnetic perturbator is thus avoided.

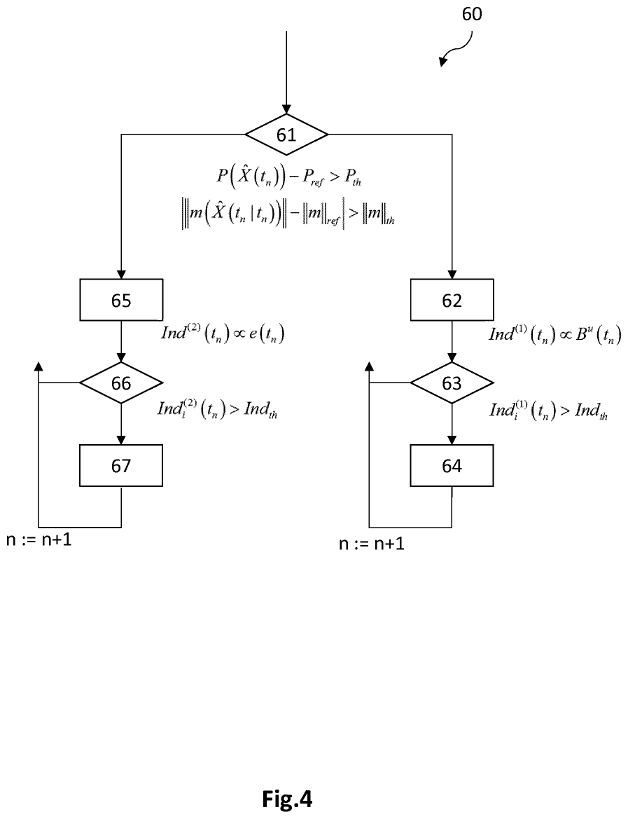

FIG. 4 illustrates a flow diagram of an identification phase 60 according to one variant of that shown in FIG. 3. In this example, the identification phase allows it furthermore to be determined whether the magnet to be tracked is present, and when such is the case, the potential presence of a magnetic perturbator to be determined. The step 61 is composed of two tests: a first test on the position of the magnetic element with respect to the tracking region (previously described), and a second test on the value of the strength of the associated magnetic moment. In this example, the coordinates (mₓ, m_{y}, m_{z}) of the magnetic moment are state variables of the vector \hat{X}, in addition to the position of the associated magnetic element.

Thus, aside from the test on the position of the magnetic element previously described, the norm ∥m(\hat{X}(tₙ|tₙ)∥ of the magnetic moment of the magnetic element is additionally compared with a reference value ∥m∥_{ref} of the magnetic moment of the magnet to be tracked, for example, equal to around 0.17 A.m². Thus, this second criterion may be written:

|∥m(\hat{X}(tₙ|tₙ))∥−∥m∥_{ref}|>∥m∥ₜₕ

where the constant may be, for example, of the order of 20% of the reference value

Thus, when the difference in the position of the magnetic element or the difference in its magnetic moment are both greater than the respective threshold difference values, it is considered that the magnetic element does not correspond to the magnet to be tracked (magnet identified as absent), and then the steps 62 and 63, previously described, are carried out for determining the presence of the magnetic perturbator. In the opposite case, in other words when the difference in the position of the magnetic element and the difference in its magnetic moment are both less than or equal to the respective threshold values, it is considered that the magnet to be tracked is present, and then the steps 65 and 66 are carried out for determining the potential presence of a magnetic perturbator situated in the neighborhood of the array of magnetometers.

During a step 65, a second indicator Ind⁽²⁾ is calculated at the current time tₙ using a difference parameter e(tₙ) defined as the norm of a difference between an estimation of the magnetic field generated by the magnet as a function of a state vector obtained at a preceding measurement time or updated on the basis of the predetermined model h, with respect to the useful magnetic field measured at the measurement time. Preferably, the indicator here is equal to the ratio between the difference parameter e(tₙ) and an estimation of the estimated magnetic field h(\hat{X}). In this example, the difference parameter e(tₙ) is equal to the norm of the innovation y(tₙ) obtained at the step 141, and the estimated magnetic field h(\hat{X}(tₙ|tₙ₋₁)) here is that corresponding to the predicted state vector \hat{X}(tₙ|tₙ₋₁). Thus, the values of the indicator Ind⁽²⁾(tₙ) may be calculated from the following relationship, here by a sensor of rank i:

$$\begin{matrix}{Ind}_{i}^{( 2 )} ( {t}_{n} ) = \frac{{e}_{i} ( {t}_{n} )}{‖ {h}_{i} ( \hat{X} ) ‖} = \frac{‖ {y}_{i} ( {t}_{n} ) ‖}{‖ {h}_{i} ( \hat{X} ( {t}_{n} \vert {t}_{n - 1} ) ) ‖} = \frac{‖ {B}_{i}^{u} ( {t}_{n} ) - {h}_{i} ( \hat{X} ( {t}_{n} \vert {t}_{n - 1} ) ) ‖}{‖ {h}_{i} ( \hat{X} ( {t}_{n} \vert {t}_{n - 1} ) ) ‖} \\ = \frac{‖ ( {B}_{i}^{p} ( {t}_{n} ) + {H}_{i}^{p , i} ( {t}_{n} ) \cdot {B}_{i}^{a} ( {t}_{n} ) ) - {ɛ}^{m} ‖}{‖ {\hat{B}}^{a} ( {t}_{n} ) + {ɛ}^{m} ‖}\end{matrix}$$

In other words, the second. indicator Ind⁽²⁾(tₙ) here is equal to the norm 2 of the innovation term y(tₙ) divided by the norm 2 of the estimation term h(\hat{X}(tₙ|tₙ₋₁))) of the magnetic field generated by the magnet, obtained at the step 132. Thus, it turns out that the magnetic contribution associated with the perturbator (term situated in the numerator) is divided by the magnetic contribution associated with the magnet (term situated in the denominator). The indicator term thus represents the force of the magnetic perturbation. As a variant, the values of the indicator term may be calculated for each measurement axis of the sensors, by adapting as appropriate the norm used. The ratio between the difference term e(tₙ) and the estimation term h may therefore be a division between terms, or a division of the norms. Thus, the indicator term may be a vector or a scalar term.

Advantageously, the indicator Ind⁽²⁾(tₙ) may comprise, in the denominator, a predetermined constant c representative of a bias of at least one magnetometer, for example a value representative of the sensor noise, for example of the order of 0.3 μT, or a value representative of a threshold of detection of a perturbator, for example of the order of 10 μT. This predetermined value may also be representative of a calibration error or of a measurement error associated with a magnetization of at least one magnetometer. Thus, the indicator Ind⁽²⁾(tₙ) may be written, here by a sensor of rank i:

$${Ind}_{i}^{( 2 )} ( {t}_{n} ) = \frac{{e}_{i} ( {t}_{n} )}{‖ {h}_{i} ( \hat{X} ) ‖ + c}$$

Thus, the values of the indicator are rendered reliable in the sense that the indicator having values that are too high is avoided, notably when the estimated magnetic field of the magnet is weak or even zero. Furthermore, not only the problem of the errors of the physical model used but also of the bias that the magnetometers may exhibit is obviated.

As a variant, the indicator Ind⁽²⁾(tₙ) may be written as the ratio of the difference parameter e(tₙ) over the predetermined constant c representative of the bias of at least one magnetometer. Thus, the problem of the measurement errors associated with the bias of the sensors is obviated, these errors being present in the term B″ present in the difference parameter e(tₙ) and in the predetermined constant c. The indicator Ind⁽²⁾(tₙ) may thus be written, here by a sensor of rank i:

$${Ind}_{i}^{( 2 )} ( {t}_{n} ) = \frac{{e}_{i} ( {t}_{n} )}{c}$$

As a variant, the indicator Indᵢ⁽²⁾(tₙ) may be written as the ratio of the difference parameter e(tₙ) over the magnetic field measured B^{u}(tₙ), with or without the predetermined constant c in the denominator. Thus, an indicator is obtained whose values vary as a function of the intensity of the signal associated with the magnetic perturbator with respect to the intensity of the estimated magnetic field generated by the magnet. The indicator Ind⁽²⁾(tₙ) may thus be written, here by a sensor i:

$${Ind}_{i}^{( 2 )} ( {t}_{n} ) = \frac{{e}_{i} ( {t}_{n} )}{‖ {B}_{i}^{u} ( {t}_{n} ) ‖}$$

During a step 66, each value Indᵢ⁽²⁾(tₙ) of the second indicator, when the latter is a vector, is compared with a second predetermined threshold identification value Indₜₕ, where the latter may be equal to the aforementioned first threshold identification value. A magnetic perturbator is the to be identified when at least one value Ind⁽²⁾(tₙ) is higher than the threshold value Indₜₕ.

During a step 67, a signal may be sent to the user inviting them to move the perturbator until each value Indᵢ⁽²⁾, at a subsequent measurement time tₙ₊₁, becomes lower than the threshold value. The signal may be a piece of information displayed on a display screen representing the array of magnetometers. The information displayed may be presented as a so-called heat map for which a scalar intensity is assigned to each magnetometer Mᵢ, the scalar intensity corresponding to a value Indᵢ⁽²⁾ of the indicator. Advantageously, the values of the indicator Ind⁽²⁾(tₙ) are weighted by a weighting factor, or even simply capped in such a manner that the values of the indicator are scaled between a minimum value, for example 0, and a maximum value, for example 255, in such a manner as to accentuate the weak magnetic perturbations. In the case where the indicator Ind⁽²⁾ does not return to a value less than the threshold value after a predetermined time delay, the initialization/reset phase 110 may be carried out.

Thus, the method 100 for tracking the magnet comprises a phase 60 furthermore allowing it to be simply identified whether the magnetic element is the magnet to be tracked or a magnetic perturbator. Indeed, the second indicator Ind⁽²⁾(tₙ) uses, in this example, the information relating to the magnetic perturbator already contained in the difference term e(tₙ). Having to use a device and method specific and dedicated to the identification of the magnetic perturbator is thus avoided.

Moreover, the calculation of the second indicator Ind⁽²⁾(tₙ) based on a ratio of the difference term e(tₙ) (here the innovation) over the estimation term h(\hat{X}) allows the component Bᵢ^{p}(tₙ)+Hᵢ^{p,i}(tₙ).Bᵢ^{a}(tₙ) associated with the magnetic perturbator to be correctly and simply differentiated with respect to the component ε^{m} associated with the errors of the physical model. Indeed, without this definition of the indicator as ratio of the difference term over the estimation term, it may be difficult to differentiate the components associated with the perturbator and with the errors of the model. Indeed, the component ε^{m} has an intensity that may vary as 1/dᵢ^{k}, with k increasing as d decreases, dᵢ being the distance separating the magnet from the magnetometer Mᵢ, this intensity being able to increase when the magnet is very close to the magnetometer Mᵢ in question, and thus to become dominant with respect to the component associated with the magnetic perturbator. In other words, the definition of the second indicator Ind⁽²⁾(tₙ) as ratio of the difference term e(tₙ) over the estimation term h(\hat{X}) allows the component associated with the magnetic perturbator to be clearly highlighted.

It also turns out that the second indicator Ind⁽²⁾(tₙ) is, after a fashion, a signal-to-noise ratio (SNR) in the sense that the useful signal here is the estimated magnetic field h(\hat{X}) and the noise associated with the presence of the magnetic perturbator is introduced by the difference between the magnetic field measured B^{u} and the estimation term h(\hat{X}).

As a variant, the step 65 for calculating the second indicator Ind⁽²⁾ of the identification phase 60 may not be carried out using the innovation term, and hence the predicted state vector \hat{X}(tₙ|tₙ₋₁) but using the updated state vector \hat{X}(tₙ|tₙ) . Thus, the second indicator Ind⁽²⁾(tₙ) may be calculated at the current time tₙ as being equal to the ratio between the difference term e(tₙ) and an estimation of the estimated magnetic field h(\hat{X}). In this example, the difference term e(tₙ) is not therefore equal to the innovation y(tₙ) obtained at the step 141, nor is the estimation h(\hat{X}) equal to the estimated magnetic field h(\hat{X}(tₙ|tₙ₋₁) obtained at the step 132. On the contrary, the estimation term present in the difference term e(tₙ) and present in the denominator is calculated using the updated state vector \hat{X}(tₙ|tₙ₋₁ and on the basis of the same physical model h. Thus, the second indicator Ind⁽²⁾(tₙ) here may be calculated using the following relationship, here with the predetermined constant c representative of the bias of at least one sensor:

$${Ind}_{i}^{( 2 )} ( {t}_{n} ) = \frac{{e}_{i} ( {t}_{n} )}{‖ {h}_{i} ( \hat{X} ) ‖ + c} \frac{‖ {B}_{i}^{u} ( {t}_{n} ) - h ( \hat{X} ( {t}_{n} \vert {t}_{n} ) ) ‖}{‖ {h}_{i} ( \hat{X} ( {t}_{n} \vert {t}_{n} ) ) ‖ + c}$$

As previously mentioned, as a variant, the second indicator may comprise the useful field measured B^{u} in the denominator instead of the estimation h, or even only the constant c.

Thus, the identification of the magnetic perturbator is rendered more precise given that the second indicator is calculated using the updated state vector rather than the predicted state vector. The difference parameter e(tₙ) only essentially differs from the innovation y(tₙ) by the state vector \hat{X} concerned. The observation function h is the same as is the useful magnetic field B^{u}.

As previously, the phase 60 for identification of the magnetic perturbator comprises the step 66 for comparison of the value or values of the indicator with a predetermined threshold value. It may furthermore comprise a low-pass filtering step with the aim of reducing the influence of the kinematics potentially present between two successive state vectors. It may also comprise a step for capping or for weighting the high values of the indicator, notably when these values correspond to a saturation of the measurement from the magnetometers concerned.

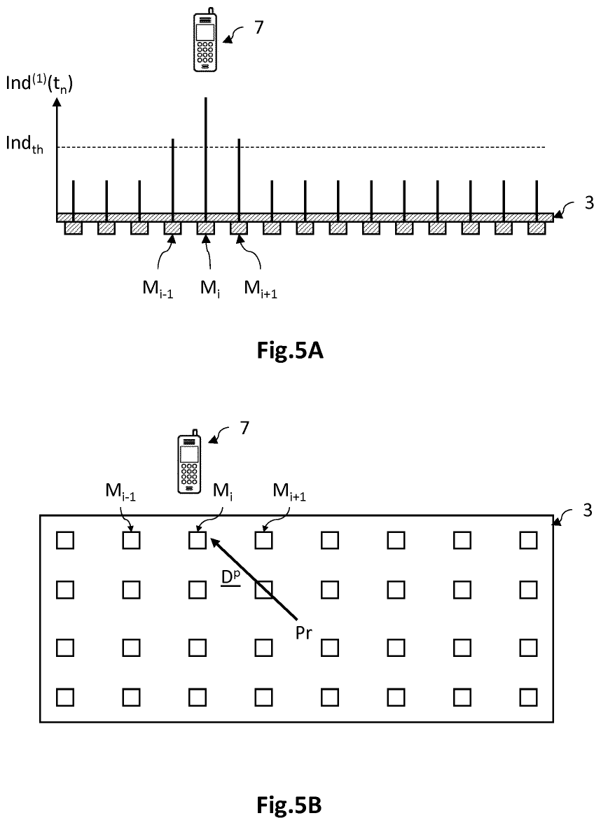

FIGS. 5A and 5B illustrate cross-sectional (FIG. 5A) and top (FIG. 5B) views of one example of an array of magnetometers in the neighborhood of which a magnetic perturbator is situated, the magnet to be tracked having been identified as being absent.

FIG. 5A illustrates one example of distribution of the values of intensity of the first perturbator Indᵢ⁽¹⁾ for each magnetometer Mᵢ. For the magnetometers Mᵢ₋₁Mᵢ and Mᵢ₊₁ in the neighborhood of which the magnetic perturbator 7 is situated, certain values of the indicator exceed the threshold value Indₜₕ so that the magnetic perturbator is correctly identified and localized. For other magnetometers, the corresponding values of the indicator are less than the threshold value.

As is illustrated in FIG. 5B, using the indicator Indᵢ⁽¹⁾ represented in the form of a heat map, a direction vector D^{p} associated with the magnetic perturbator may be calculated and displayed. The direction vector D^{p} may be obtained from the average of the positions of the magnetometers, each weighted by the corresponding scalar perturbation intensity, and the position of the center Pr of the array of magnetometers. Thus, the user receives information indicating the direction in which the perturbator is situated with respect to the array of magnetometers. They are then able to proceed with the removal of the perturbator outside of the neighborhood of the magnetometers.

The method 100 provides the tracking of the magnet, and hence iterates the measurement phase 120, the phase 130 for estimating the magnetic field generated, the phase 140 for calculating the bias (here the innovation), and the phase 150 for calculating the estimated position of the magnet. Upon each incrementation of the measurement time, the phase 60 for identifying the magnetic perturbator is carried out.

In the case where the magnetic perturbator is still present in the neighborhood of the array of magnetometers, the phase 150 for calculating the estimated position of the magnet may be carried out without taking into consideration the measurement values coming from the magnetometers Mᵢ₋₁, Mᵢ and Mᵢ₊₁, for which the indicator exhibits local values higher than the threshold value.

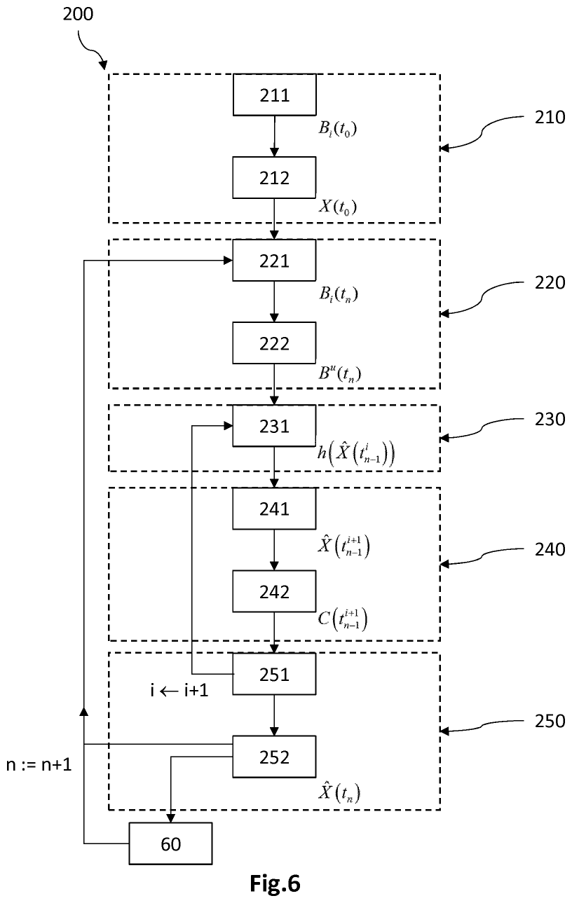

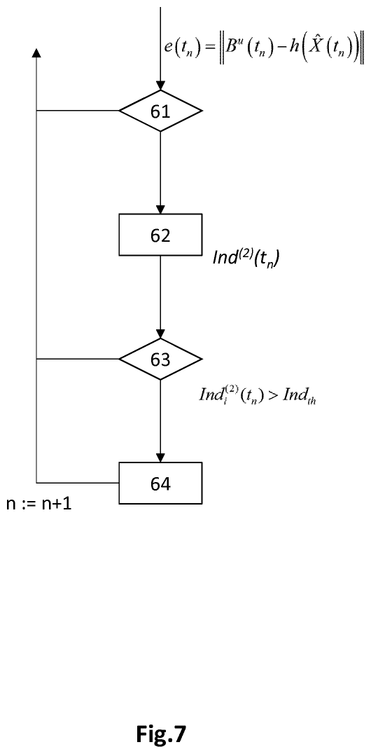

FIGS. 6 and 7 each illustrate a flow diagram partially representing a tracking method 200 according to a second embodiment. The estimation algorithm implemented is then an optimization, notably by minimization of a cost function, here by a gradient descent. The identification phase 60 remains similar to that described previously, and essentially only differs from the latter by the definition of the difference term e(tₙ) in the step 65 for calculating the second indicator Ind⁽²⁾.

The method 200 comprises an initialization/reset phase 210 of and a phase 220 for measuring the magnetic field Bᵢ(tₙ) and for calculating the useful magnetic field B^{u}(tₙ). These phases are identical or similar to those described previously and are not detailed here.

It furthermore comprises several phases 230, 240, 250 carried out successively, for the same measurement time tₙ, in an iterative loop for minimization of a cost function C. The state vector \hat{X}(tₙ) at the measurement time tₙ is thus obtained by successive correction, according to the increment i, of the state vector \hat{X}(tₙ₋₁) of the preceding measurement time tₙ₋₁. It thus comprises a phase 230 for estimating the magnetic field generated as a function of a state vector previously obtained, a phase 240 for calculating a bias, here a cost function C, and a phase 250 for calculating the estimated position of the magnet at the current time tₙ.

The phase 230 for estimating the magnetic field h(\hat{X}) generated for a state vector previously obtained is similar to the phases 130 previously described. At the measurement time tₙ, this will be the state vector obtained during the phase 250 at the preceding measurement time tₙ₋₁ or the state vector (t₀) defined during the initialization/reset at the time t₀, potentially corrected as a function of the increment i of the iterative correction of minimization of a cost function C. The measurement time tₙ₋₁ at the increment i is thus denoted tₙ₋₁ⁱ.

Thus, during a step 231, the estimated magnetic field h(\hat{X}(tₙ₋₁ⁱ)) corresponding to the state vector \hat{X}(tₙ₋₁ⁱ) previously obtained at the measurement time tₙ₋₁, potentially corrected as a function of the increment i, is calculated at the current time tₙ. When the increment i is equal to 1, the correction loop has not yet gone round once and the state vector \hat{X}(tₙ₋₁¹) is that \hat{X}(tₙ₋₁) calculated at the step 252 of the phase 250. When the increment i is greater than 1, the correction loop has already gone round once and the state vector differs from that \hat{X}(tₙ₋₁) calculated at the step 252 by at least one correction term. As previously detailed, the estimated magnetic field h(\hat{X}) is calculated based on the observation function h, also referred to as measurement function.

The phase 240 for calculating the bias, here the cost function C to be minimized, comprises a step 241 for correction of the state vector, followed by a step for calculating the cost function C.

During the step 241, the state vector at the preceding increment is corrected according, in this example, to a relationship corresponding to a gradient-descent algorithm:

$$\begin{matrix}\hat{X} ( {t}_{n - 1}^{i + 1} ) = \hat{X} ( {t}_{n - 1}^{i} ) - μ \cdot {∇}_{X} [ C ( \hat{X} ( {t}_{n - 1}^{i} ) ) ] \\ = \hat{X} ( {t}_{n - 1}^{i} ) - μ \cdot {∇}_{X} [ f ( h ( \hat{X} ) - {B}^{u} ( {t}_{n} ) ) ]\end{matrix}$$

where μ is the step whose value, positive, may depend on the increment i, ∇x is the gradient operator as a function of the variables of the state vector, and C(\hat{X}) the cost function to be minimized, which depends on the difference between an estimated magnetic field h(\hat{X}) and the measured useful magnetic field B^{u}. By way of illustration, the preceding relationship may be written, here in the case of least squares where the cost function may then be written C=∥h(\hat{X})−B^{u}∥²:

$$\begin{matrix}\hat{X} ( {t}_{n - 1}^{i + 1} ) = \hat{X} ( {t}_{n - 1}^{i} ) - μ \cdot {∇}_{X} [ C ( \hat{X} ( {t}_{n - 1}^{i} ) ) ] \\ = \hat{X} ( {t}_{n - 1}^{i} ) - 2 μ \cdot {H}^{T} ( \hat{X} ( {t}_{n - 1}^{i} ) ) \cdot ( h ( \hat{X} ( {t}_{n - 1}^{i} ) ) - {B}^{u} ( {t}_{n} ) )\end{matrix}$$

where H^{T} is the transpose of the Jacobian of the observation function h applied to the state vector at the measurement time tₙ₋₁ and at the increment i. Other expressions are of course possible, for example, in the framework of a Gauss-Newton, or even of a Levenberg-Marquardt method.

During the step 242, the norm ∥C∥ of the cost function C is calculated. Several expressions are possible, for example, ∥h(\hat{X})−B^{u}(tₙ)∥².

The phase 250 for calculating the estimated position, at the current time tₙ, comprises a step 251 in which the norm ∥C∥ is compared to a threshold. When ∥C∥ is greater than the threshold, the increment i is increased by one iteration, and the minimization loop continues from the step 231 applied to the corrected state vector. When ∥C∥ is less than or equal to the threshold, in the step 252, the value of the estimated state vector i(tₙ) for the current time tₙ, which takes the value of the corrected state vector \hat{X}(tₙ₋₁ⁱ⁺¹), is then obtained. The time is subsequently incremented by an additional increment, and the method iterates the steps previously described at the next current time tₙ₊₁, here starting from the measurement phase 210. The tracking of the magnet in the reference frame XYZ is thus carried out.

The tracking method 200 also comprises the identification phase 60, the latter being carried out based on the estimated state vector i(tₙ) for the current time tₙ, obtained at the step 252. It is similar to that previously described.

During the step 65, the second indicator Ind⁽²⁾(tₙ) is calculated at the current time tₙ as being equal to the ratio between the difference term e(tₙ) and an estimation of the estimated magnetic field h(\hat{X}). In this example, the difference term e(tₙ) is equal to the norm of the difference between the magnetic field h(\hat{X}(tₙ)) estimated for the state vector \hat{X}(tₙ) obtained at the step 252, and the measured magnetic field B^{u}(tₙ). Thus, the second indicator Ind⁽²⁾(tₙ) may be written, here with the predetermined constant c in the denominator:

$${Ind}_{i}^{( 2 )} ( {t}_{n} ) = \frac{{e}_{i} ( {t}_{n} )}{‖ {h}_{i} ( \hat{X} ( {t}_{n} ) ) ‖ + c} \frac{‖ {B}_{i}^{u} ( {t}_{n} ) - {h}_{i} ( \hat{X} ( {t}_{n} ) ) ‖}{‖ {h}_{i} ( \hat{X} ( {t}_{n} ) ) ‖ + c}$$

Thus, the difference parameter e(tₙ) essentially only differs from the bias, here the cost function C, by the state vector X concerned. The observation function h is the same as is the useful magnetic field B^{u}.

As a variant, as previously mentioned, the indicator may comprise, in the denominator, the measured magnetic field B^{u} instead of the estimation h(\hat{X}) , with or without the predetermined constant c, or even the predetermined constant c alone.

As previously, the identification phase 60 comprises the step 66 for comparing the value or values of the indicator with a predetermined threshold value. It may furthermore comprise the low-pass filtering step with the aim of reducing the influence of the kinematics potentially present between two successive state vectors. It may also comprise a step for capping or for weighting high values of the indicator, notably when these values correspond to a saturation of the measurement of the magnetometers concerned.

Particular embodiments have just been described. Numerous variants and modifications will be apparent to those skilled in the art.

1. A method for estimating the position of a magnet by a tracking device comprising an array of magnetometers designed to measure a magnetic field, the method being implemented by a processor, comprising the following phases:
determination of an initial state vector, associated with the magnet, for an initial measurement time, the state vector comprising variables representative of the position of the magnet with respect to the array of magnetometers;
measurement by the array of magnetometers of a useful magnetic field produced by a magnetic element, at a measurement time;
estimation of a magnetic field generated by the magnet, as a function of the state vector obtained at a preceding measurement time, on the basis of a predetermined model expressing a relationship between the magnetic field generated by the magnet and the state vector of the magnet;
calculation of a bias by a difference between the estimated magnetic field generated by the magnet and the useful magnetic field measured produced by the magnetic element;
update of the state vector as a function of the calculated bias, thus allowing an estimated position of the magnet at the measurement time to be obtained; and
iteration of the phases for measurement, for estimation, for calculating the bias and for updating, on the basis of the updated state vector, while incrementing the measurement time;
wherein the method further comprises an identification phase, at at least one measurement time, comprising the following steps:
calculation of a difference between at least one variable of the updated state vector and a predetermined reference value representative of the presence of the magnet with respect to the array of magnetometers, and identification of the absence of the magnet when the difference is greater than a predetermined threshold difference value, in which case the following steps are carried out:
calculation of an indicator, from the useful magnetic field measured at the measurement time; and
comparison of the indicator with a predetermined threshold identification value, and identification of the magnetic element as being a magnetic perturbator when at least one of the values of the indicator is greater than or equal to the threshold identification value.

2. The method of claim 1, in which the indicator is equal, at the measurement time, to the ratio of the useful magnetic field over at least one predetermined constant representative of a bias of at least one of the magnetometers.

3. The method of claim 1, in which the step for calculating the difference comprises a comparison of an estimated position of the magnetic element coming from the state vector with a predetermined reference position representative of the presence of the magnet with respect to the array of magnetometers.

4. The method of claim 1, in which, the state vector furthermore comprising variables representative of a magnetic moment of the magnetic element, the step for calculating the difference comprises a comparison of an estimated magnetic moment of the magnetic element coming from the state vector with a reference magnetic moment representative of the magnet.

5. The method of claim 3, in which the step for calculating a difference comprises an identification of the presence of the magnet with respect to the array of magnetometers when the differences relating to the position and to the magnetic moment of the magnetic element are less than or equal to predetermined threshold difference values, in which case the following steps are carried out:
calculation of a second indicator, using a difference parameter defined as being a function of a difference between an estimated magnetic field generated by the magnet for the state vector obtained at the preceding measurement time or updated on the basis of the predetermined model, and the useful magnetic field measured at the measurement time; and
comparison of the second indicator with a predetermined second threshold identification value, and identification of a magnetic perturbator when at least one of the values of the indicator is greater than or equal to the second threshold identification value.

6. The method of claim 1, in which the phases for estimation, for calculating the bias and for updating are carried out by a Bayesian recursive estimation algorithm.

7. The method of claim 6, in which the estimation phase comprises:
a step for obtaining a predicted state vector, at the measurement time as a function of a state vector obtained at a preceding measurement time, and
a step for calculating the estimated magnetic field for the predicted state vector,
wherein the phase for calculating the bias comprises:
a step for calculating the bias, referred to as innovation, as the difference between the estimated magnetic field for the predicted state vector and the useful magnetic field measured.

8. The method of claim 7, in which the difference parameter is equal to the innovation.

9. The method of claim 7, in which the difference parameter is equal to the difference between an estimated magnetic field generated by the magnet for the updated state vector, and the useful magnetic field measured at the measurement time.

10. The method of claim 1, in which the phases for estimation, for calculating the bias and for updating are carried out by an algorithm for optimizing by iterative minimization of the bias, referred to as cost function, at the measurement time.

11. The method of claim 1, in which the phase for identification of the magnetic perturbator comprises a step for sending a signal to the user inviting them to move the magnetic perturbator away from the array of magnetometers, for as long as at least one of the values of the indicator is greater than or equal to a predetermined threshold identification value.

12. An information recording medium, comprising instructions for the implementation of the method of claim 1, these instructions being executable by a processor.
